(19) United States
(12) Patent Application Publication
(10) Pub. No.: US 2004/0068675 A1
(43) Pub. Date: Apr. 8, 2004

(54) Circuit board having boundary scan self-testing function

(76) Inventor: Meng-Hsien Liu, PaTe City (TW)

Correspondence Address: Harold V. Stotland, Seyfarth Shaw, 42nd Floor, 55 East Monroe Street, Chicago, IL, 60603-5803, US

(21) Appl. No.: 10/653,820

(22) Filed: Sep. 2, 2003

(30) Foreign Application Priority Data
Oct. 8, 2002 (TW) 091123247

(51) Int. Cl. H04L 1/22

(52) U.S. Cl. 714/27

(57) ABSTRACT

A circuit board with a boundary scan self-testing function comprises a substrate, a plurality of devices under test and an active testing device. The active testing device mounted the substrate can conduct circuit testing on the plurality of devices under test, and self-testing is allowed without employing any external testing equipment. The testing data of the active testing device is transmitted through a predetermined test route on the circuit board. Each of the devices under test is completely tested of all designated functions in either series connection or parallel connection with each other. The testing can help find out whether the devices have any defects.

### BACKGROUND OF THE INVENTION

1. Field of the Invention

The present invention relates to a circuit board having a boundary scan self-testing function, and more particularly to a circuit board capable of actively conducting circuit testing by its built-in self-testing function.

2. Description of the Related Art

Boundary scan is a very successful testing method first developed by JTAG (Joint Test Action Group) during the 80 s. At the beginning, this testing method was developed for testing circuit boards or system levels, and has been widely accepted by the industry up until now. Boundary scan has become the standard IEEE 1149.1 that most IC designers have followed. This standard defines that specific testing circuits embedded in key IC devices on a circuit board can perform various chip-level tests at a board level.

In recent years, the requirements of the consumer market have not only driven electronic products to have smaller sizes, such as phones and digital cameras, but also to have more built-in functions, faster processing speeds, and shorter life cycles. On the other hand, these requirements have made electronic devices more complicated, requiring more sophisticated electrical packaging and narrowing the line widths on circuit boards. Therefore, the traditional probe test has encountered a tremendous handicap. During electrical testing of devices having a larger number of pins or smaller pitch between its pins, the reliability of manufacturing and testing processes regarding the testing sockets must face the challenges resulting from these factors. In order to overcome such challenges, the costs will inevitably go up. For example, when the packaging type of devices is a flip-chip or BGA with more than 500 pins, the traditional probe is not adequate for testing such devices.

A conventional technique provides a chip level test that is conducted on a circuit board directly to detect each predetermined device thereon rather than by an ATE (Auto-Testing Equipment) with an expensive computer. FIG. 1 is a diagram of the testing route for a boundary scan test conducted on a conventional circuit board. There are devices under test with boundary scan circuits, such as a device 111, a CPLD (complex programmable logic device) 112, and a processor 113, mounted on the substrate 13 of the circuit board 10. An ATE 15 is connected to TAPs (Test Access Ports) 17, and then corresponding test patterns are input into the TAP 17 to automatically trigger various testing processes for all devices in a sequence (along the directions of the arrows marked on FIG. 1) through a testing route 14. Therefore, one device passes testing signals to the next device, and a final testing result is sent back to the ATE 15 through the TAPs 17. The boundary scan function is also available to detect whether each of the pins of a device without a boundary scan circuit, such as a device 12, a DRAM 18, and a flash memory 19, is in normal connection with the substrate 13. Through TAPs 17, not only the boundary scan testing can be conducted but also specific program codes can be written into a CPLD 112 through the testing route 14. In addition, specific data can be stored in the flash memory 19 to execute an in-system programming function.

However, since the boundary scan testing still needs to be carried out by the ATE 15 away from the circuit board 10, the testing service fees are obviously high. In addition, the CPLD 112 on the substrate 13 cannot effectively and simultaneously detect all errors. Therefore, we have to overcome these problems so as to have a superior automatic testing technique.

### SUMMARY OF THE INVENTION

The first objective of the present invention is to provide a circuit board equipped with a boundary scan self-testing function. When the system equipment comprising the circuit board is powered on, the circuit board automatically starts a self-testing process due to a boundary scan activating device mounted on it.

The second objective of the present invention is to provide a circuit board capable of writing program codes into programmable devices. The program codes can be directly written into CPLDs or FPGA (Field Programmable Gate Array) devices mounted on the circuit board. The board-level code writing shortens the writing time from external automatic testing equipment to write codes.

The third objective of the present invention is to reduce the costs for testing a circuit board. Boundary scan testing can be conducted without using any expensive external automatic testing equipment.

In order to achieve the objectives, the present invention discloses a circuit board with a boundary scan self-testing function. An active testing device mounted on the circuit board can conduct circuit testing on a plurality of devices under test thereon, and self-testing is allowed without employing any external testing equipment. The testing data of the active testing device is transmitted through a predetermined route on the circuit board. Each of the devices under test is completely tested for all designated functions in either series connection or parallel connection with each other. The testing can help find out whether the devices have any defects.

The circuit board with a boundary scan self-testing function includes a substrate, a plurality of devices under test and an active testing device. The devices under test in which boundary scan circuits are embedded are mounted on the surface of the substrate. The active testing device is also mounted on the surface of the substrate, and forms a testing route with all the devices under test in sequence. In addition, the active testing device can generate boundary scan testing data, and the data is inputted into the devices under test through the testing route.

### BRIEF DESCRIPTION OF THE DRAWINGS

The invention will be described according to the appended drawings in which:

FIG. 1 is a diagram of the testing route for a boundary scan test conducted on a conventional circuit board;

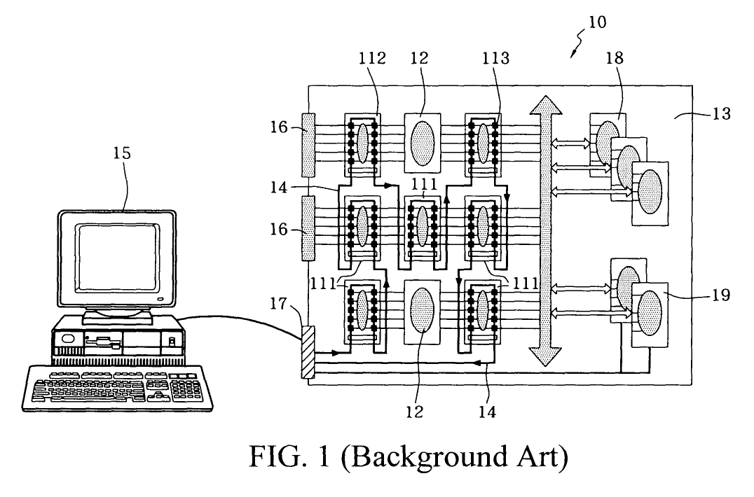

FIG. 2 is a schematic diagram of the device with a boundary scan circuit;

FIG. 3 is a diagram of the testing route for a boundary scan test conducted on a circuit board in accordance with the present invention; and

FIG. 4 is a diagram of the testing signal transmission on a circuit board during a self-testing process in accordance with the present invention.

### PREFERRED EMBODIMENT OF THE PRESENT INVENTION

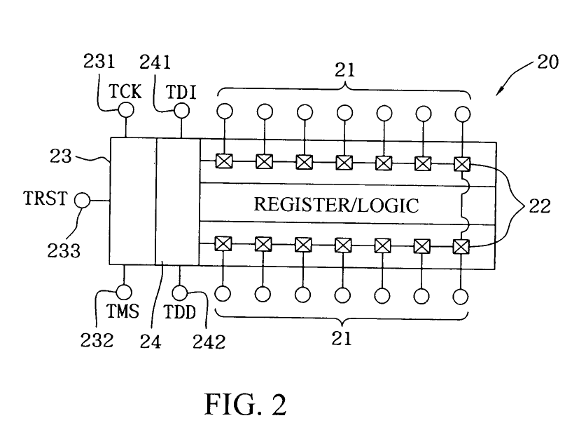

FIG. 2 is a schematic block diagram of the device with a boundary scan circuit. The device 20 has several functional pins 21 extending from both sides of it. The functional pins 21 are for the execution of the functions assigned by the device 20. Each of the functional pins 21 is connected to a boundary register cell 22 capable of inputting and outputting data. One of the boundary register cells 22 is a shift register that connects to the adjoining one, and all the boundary register cells 22 are in a series connection with each other to form a boundary register. TAPs (Test Access Ports) 23 are the core of the device 20, and has various functional pins designated as follows: TCK (Test Clock Input) 231, TMS (Test Mode Selector) 232, and TRST (Test Reset Input) 233. In addition, the functional pins of TDI (Test Data Input) 241 and TDO (Test Data Output) 242 are, respectively, an input terminal and an output terminal for testing signals for the device 20. These two pins are connected to an IR (instruction register) 24.

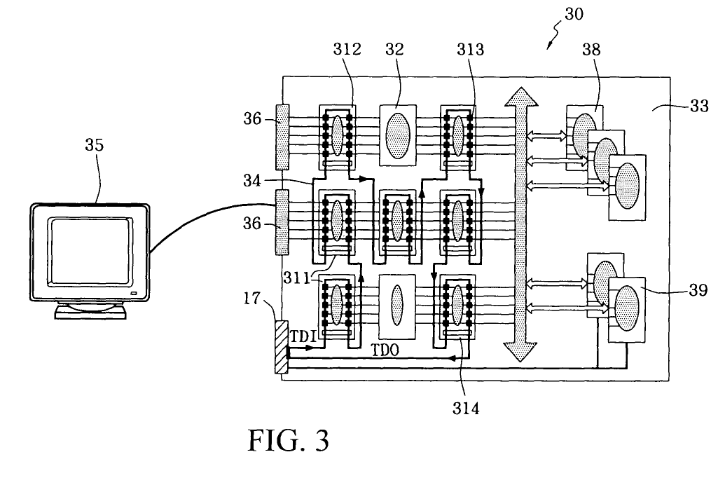

FIG. 3 is a diagram of the testing route for a boundary scan test conducted on a circuit board in accordance with the present invention. It is characterized in that an active testing device 314 capable of generating predetermined testing patterns for a boundary scan test is mounted on the substrate 33 of a circuit board 30. The active testing device 314 is in a parallel connection with the devices 311 to be tested through a testing route 34. On the testing route 34, the active testing device 314 sends out TMS, TRST, and TCK signals to all the devices 311 to be tested. The TDI and TDO signals are alternatively applied on the devices 311 to be tested in sequence. When one of the devices 311 to be tested sends out signals from its TDO pin, the signals will become input signals for the TDI pin of the next device 311 to be tested. In the same way, each of the devices 311 to be tested input and output testing data or testing signals in a sequence (along the direction of arrows marked on FIG. 3).

On the testing route 34, the active testing device 314, the devices 311 to be tested, a CPLD 312, and a processor 313 all have boundary scan circuits embedded in themselves. The active testing device 314 is a micro-controller with embedded memory in which system designers can write testing programs. The micro-controller can compare test results with a specified result and transmit the test results to a display 35 through a I/O Port 36. When the circuit board 30 is connected to the motherboard of a system and the system is powered on, the circuit board 30 conducts a complete boundary scan test by itself. This boundary scan self-testing reduces the burden of corresponding confirmation procedures in the prior art. The testing route 34 can also be set to bypass some minor devices under test for saving testing time. The boundary scan self-testing can also be applied to devices without boundary scan circuits, such as a device 32, a DRAM 38 and a flash memory 39, for detectting whether each of the pins of the device is in a normal connection or a poor connection with the substrate 33. In addition, the active testing device 314 not only can execute a boundary scan self-test but also can write specific program codes into the CPLD 312 through the testing route 34 or record data on the flash memory 39. Of course, the CPLD 37 can be replaced with a FPGA or a GAL. Since the active testing device 314 and the CPLD 312 are sequentially placed on the same testing route 34, both the writing and retrieving of data can be conducted easier than the prior art does.

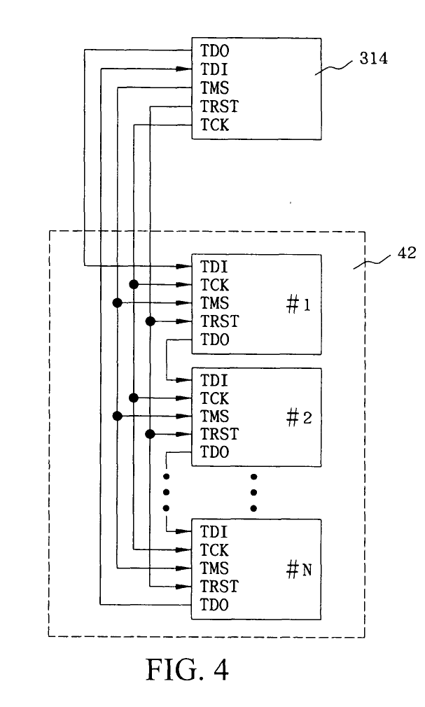

FIG. 4 is a diagram of the testing signal transmission on a circuit board during a self-testing process in accordance with the present invention. As shown in FIG. 4, the active testing component 314 sends out testing data or program codes through a TDO pin to the TDI pin of the first device 311 to be tested in a testing group 42, and then the first device 311 tested sends signals from its TDO pin to the TDI pin of the next device 311 to be tested. And so forth, the testing route 34 connects all the devices 311 to be tested in series, and the TDO pin of the last device 311 to be tested finally sends signals out to the TDI pin of the active testing device 314. The TCK, TMS and TRST signals are sent to the corresponding pins of all devices 311 to be tested by the active testing device 314 in parallel.

The above-described embodiments of the present invention are intended to be illustrative only. Numerous alternative embodiments may be devised by persons skilled in the art without departing from the scope of the following claims.

What is claimed is:

1. A circuit board having a boundary scan self-testing function, comprising:
a substrate;
a plurality of devices under test mounted on the substrate and having boundary scan circuits; and
an active testing device mounted on the substrate and used for generating boundary scan testing data sequentially forwarding to the devices under test along a testing route.

2. The circuit board having a boundary scan self-testing function of claim 1, wherein the devices under test include programmable devices.

3. The circuit board having a boundary scan self-testing function of claim 2, wherein the programmable devices are complex programmable logic devices or field programmable gate array devices.

4. The circuit board having a boundary scan self-testing function of claim 1, wherein the active testing device includes TCK, TMS and TRST pins which connect the devices under test in parallel, and further includes TDI and TDO pins which connect the devices under test in series.

5. The circuit board having a boundary scan self-testing function of claim 1, wherein the substrate further includes at least one I/O port for outputting test results of the active testing device.

6. The circuit board having a boundary scan self-testing function of claim 4, wherein the substrate includes test access ports having a short circuit between the TDI and TDO pins.

7. The circuit board having a boundary scan self-testing function of claim 2, wherein the active testing device has program codes of the programmable devices, which can be written into the programmable devices through the testing route.
